(19) United States
(12) Patent Application Publication
(10) Pub. No.: US 2024/0159331 A1
(43) Pub. Date: May 16, 2024

(54) PLASTIC/FIBERGLASS VENT WITH FASTENER AND COMPRESSION LIMITER

(71) Applicant: Dana Automotive Systems Group, LLC, Maumee, OH (US)

(72) Inventors: Dakota Rene DAWSON, Fort Wayne, IN (US); Steven Thomas BYRNE, Holland, OH (US); Zhongli YOU, Toledo, OH (US); Kendall Christopher KNIGHT, Sylvania, OH (US); Karlie MANOR, Toledo, OH (US); Channing CECIL, Delta, OH (US)

(21) Appl. No.: 18/056,225

(22) Filed: Nov. 16, 2022

(51) Int. Cl. F16L 9/19; F16H 57/027; F16L 5/10; F16L 5/14; F16L 43/00; F16L 57/02

(52) U.S. Cl. CPC F16L 9/19; F16H 57/027; F16L 5/10; F16L 5/14; F16L 43/008; F16L 57/02

(57) ABSTRACT

A mountable vent, comprising: a first hollow portion with a seal groove; a second hollow portion in fluid communication with the first hollow portion; an extension of the second hollow portion in fluid communication with the second hollow portion; and a fastening portion with a compression limiter for at least one fastener to attach the mountable vent to a housing, where the fastening portion radially extends from the first hollow portion or the second hollow portion and is positioned between the seal groove and the extension.

### TECHNICAL FIELD

The present description relates to a vent with fastener and compression limiter. The vent may be modular for universal or near universal use with other Dana components.

### BACKGROUND AND SUMMARY

Vehicles may include a plurality of enclosures. Vehicles may include a drive train with a transmission. The transmission may include a gear box with plurality of gearsets with a plurality of gears. Gear boxes and other components with an enclosed space of a vehicle may use vents to remove hot air or other fluids to mitigate thermal energy and pressure. Vents near a gear box may be located near an axle housing.

The complexity and quantity of different embodiments of vents may reduce the ability to use vents interchangeably in various components. For example, a first embodiment of a vent may be unable to be used in the same role as a second embodiment of a vent for similar component on a different vehicle. Additionally, vents that are formed of metals, such as steel, may add additional weight to a vehicle. Steel in particular may be brittle and may make a vent more prone to degradation. Likewise, a coupling between a vent to a component created via the use of a sealant, such as a silicone sealant, such as hydrolomar, and/or a press fit with a sealant may be prone to degradation. The use of steel and a sealant and/or press fit may make a vent vulnerable to degradation. Such degradation to the vent may result in further degradation to other components and/or hinder the function of vehicle, such as if the vent becomes stuck in an axle housing. Vents formed of plastic or fiberglass may be used in place of metals to reduce weight and brittleness of the vent. However, vents formed of plastic or fiberglass may still use a sealant and press fit to couple to a component.

The inventors herein have recognized these and other issues with such systems. In one example, a mountable vent comprises a first hollow portion with a seal groove, a second hollow portion in fluid communication with the first hollow portion; an extension of the second hollow portion in fluid communication with the second hollow portion; and a fastening portion with a compression limiter for at least one fastener to attach the mountable vent to a housing, where the fastening portion radially extends from the first hollow portion or the second hollow portion and is positioned between the seal groove and the extension.

In this way, by having the vent coupled to a component via a fastener and fastening portion, the vent may be installed or uninstalled with greater ease compared to a press fit. The vent may not use sealants, such as hydrolomar, that are applied and cured to install and removed through a degradative process to uninstall, to seal and fluidly couple the vent to an enclosure. The vent may be installed by hand at any point in the manufacturing process and may be made modular and universal across multiple components. The compression limiter may reduce degradation to the material of the vent from over torqueing the fastener or from compressive and/or other mechanical forces applied to the vent. If degradation occurs to the vent, the vent may be prevented from sliding along an axis out of a hole, and the vent may be prevented from contacting and degrading the axle.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 shows an example schematic of a vehicle which may include a gear box and transmission.

FIG. 2 shows an example schematic of the components of a vent within the gear box and transmission.

FIG. 3 shows a first perspective view of an example vent isolated from other components.

FIG. 4 shows a first side view and the height of the example vent from FIG. 3.

FIG. 5 shows a second side view with dimensions of features of the vent from FIG. 3.

FIG. 6 shows a first sectional view taken on a line in FIG. 4 of the example vent from FIG. 3 showing dimensions of various features.

FIG. 7A shows a second sectional view and features of a first area of the example vent from FIG. 3.

FIG. 7B shows the second sectional view and features of the first area coupled to a ring.

FIG. 7C shows a third sectional view and features of a second area from FIG. 7A-B.

FIG. 8A shows a third side view from above the vent of FIG. 3.

FIG. 8B shows a fourth sectional view taken on a line in FIG. 5 from below the vent of FIG. 3.

FIG. 9 shows a fifth sectional view of a third area taken on a line in FIG. 8A-B.

### DETAILED DESCRIPTION

The description relates to a vent that may be used to remove gases from an enclosure, such as a gear box and/or transmission, within a vehicle. The vent may be modular and universal, wherein the vent may be compatible with multiple configurations of enclosures. The vent may be coupled to an enclosure without the use of a sealant and/or a press fit, instead the enclosure may be sealed by the vent using a removable seal, such as an O-ring. The vent may be formed of plastic or fiberglass. The vent may have a first portion and a second portion that are hollow and fluidly coupled. The first portion and second portion may form a passageway. The passageway of the vent may extend into and be fluidly coupled to the interior of the enclosure. Fluids such as gases may travel through the passageway.

The vent has a fastening portion. The fastening portion may extend radially from the first and/or second portions of the vent, with respect to a central axis. The fastening portion may be coupled to the surface of a housing forming the enclosure via a fastener, such as a bolt. However, it is to be appreciated that the formation of the first and second bore may be non-limiting. The fastening portion incorporates a compression limiter. The fastener may be passed through a hole formed by the compression limiter and a complimentary hole in the housing that forms the enclosure. The fastener may couple to the sides of at least the complementary hole and/or the hole formed by the compression limiter connectable interaction devices, such as a threading. At least the complementary hole has connectable interaction devices, such as threading, complementary to the fastener. Likewise, the hole in the fastening portion may have connectable interaction devices complementary to the fastener. When coupled, the fastener may be engaged with the connectable interaction device, for example the fastener may be threaded with a threading. When engaged with the connectable interaction device, the fastener may couple the fastening portion and vent to the housing of an enclosure.

The vent may have a groove. A seal that is detachable, such as an O-ring, may be positioned about the groove. The seal may prevent at least liquids, such as lubricant, and may prevent gases in the enclosure from exiting except through the passage of the vent. The ability of the seal to be detached allows for the seal to be replaced. Both the detachable seal and the fastening portion may allow the vent to be modular and universal for a plurality of configurations of enclosures and housing around the enclosures.

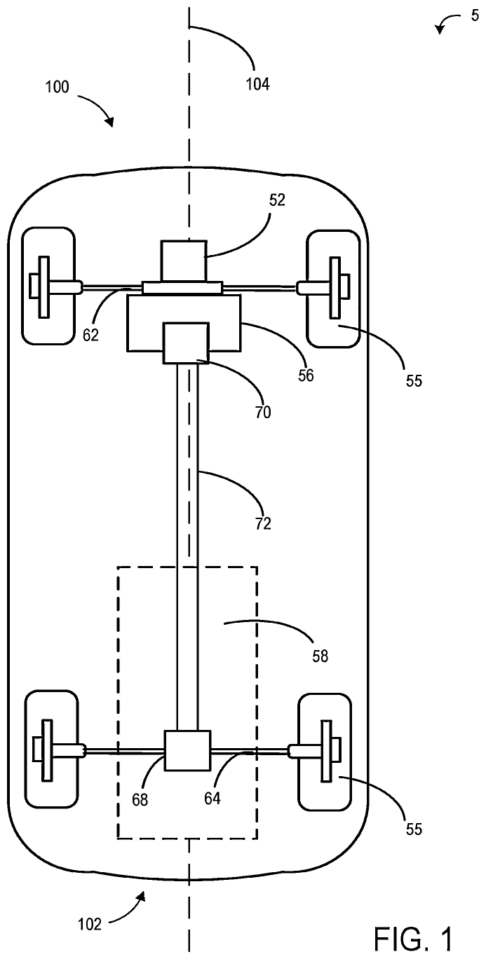

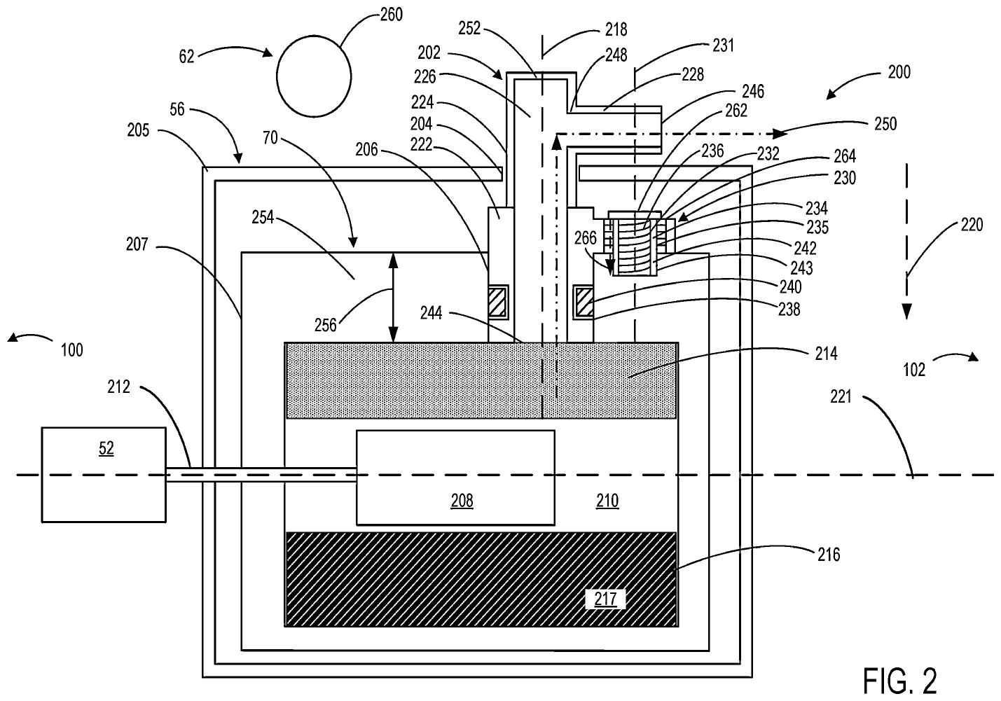

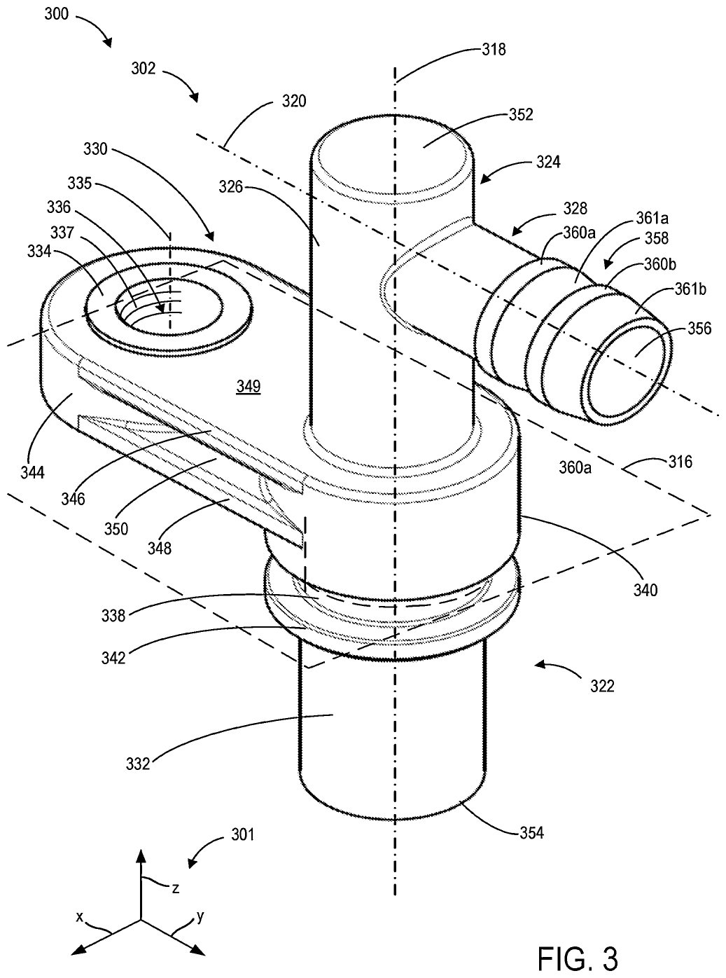

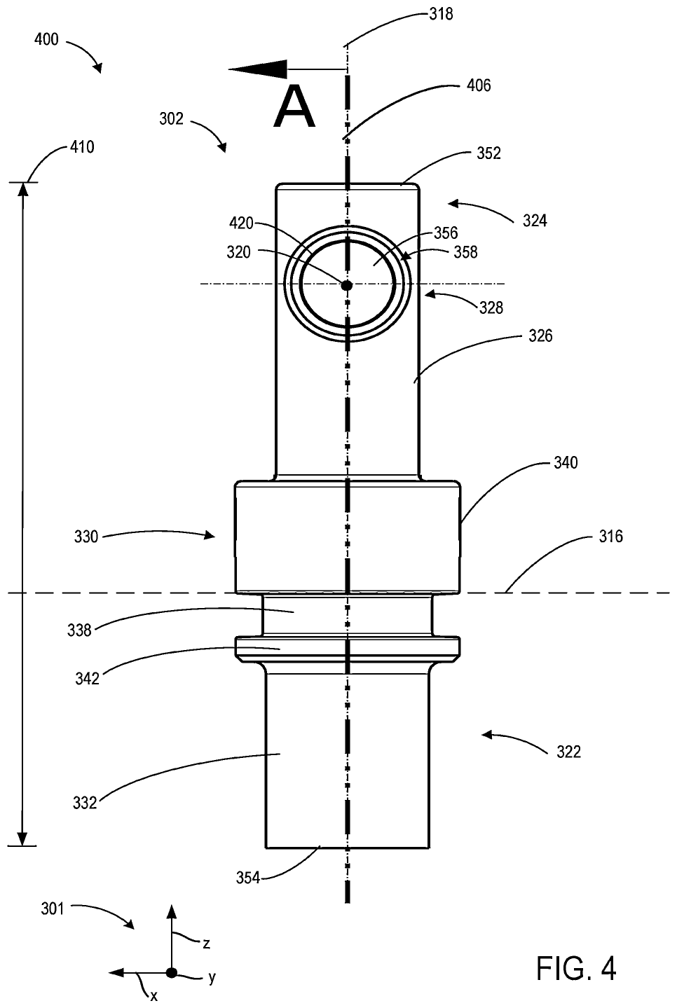

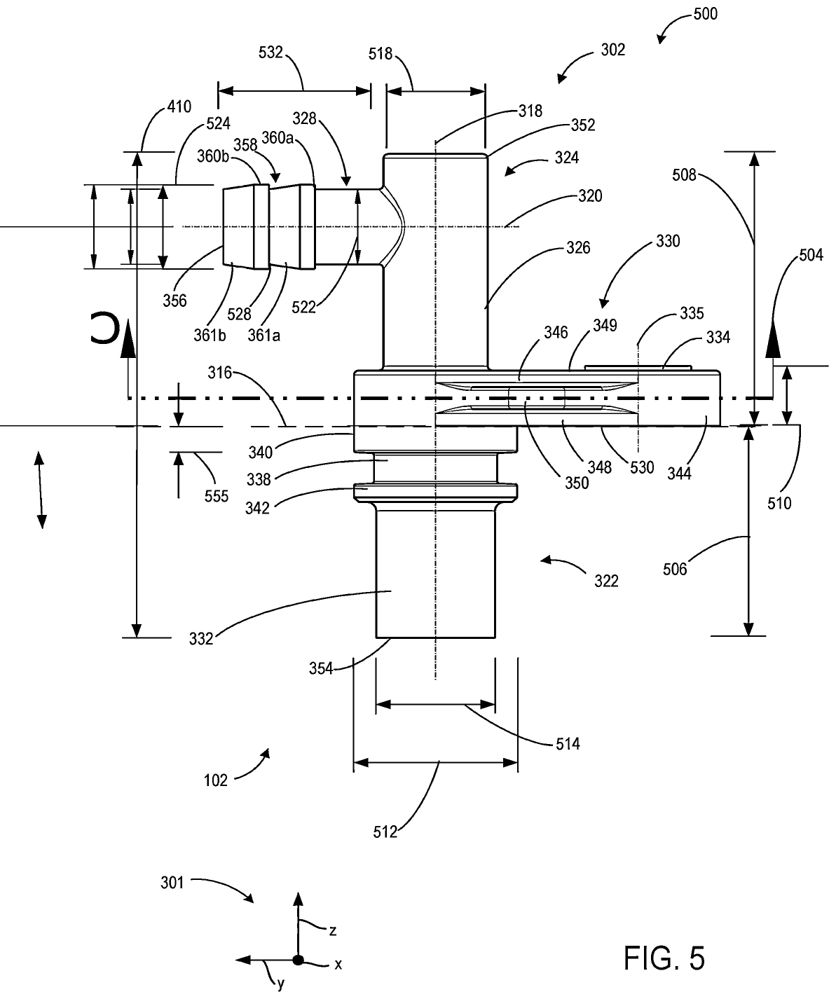

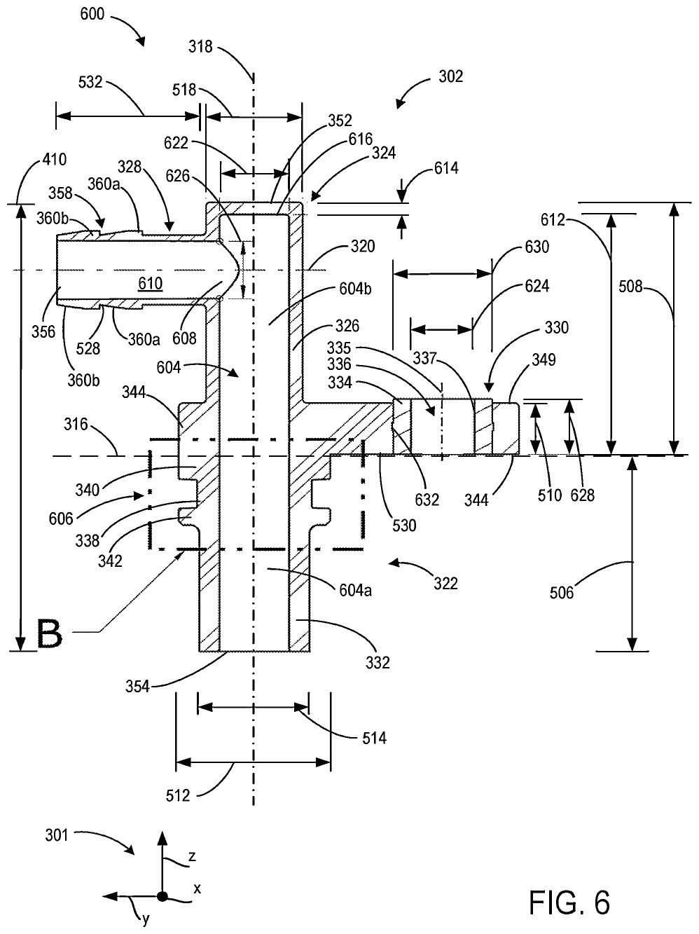

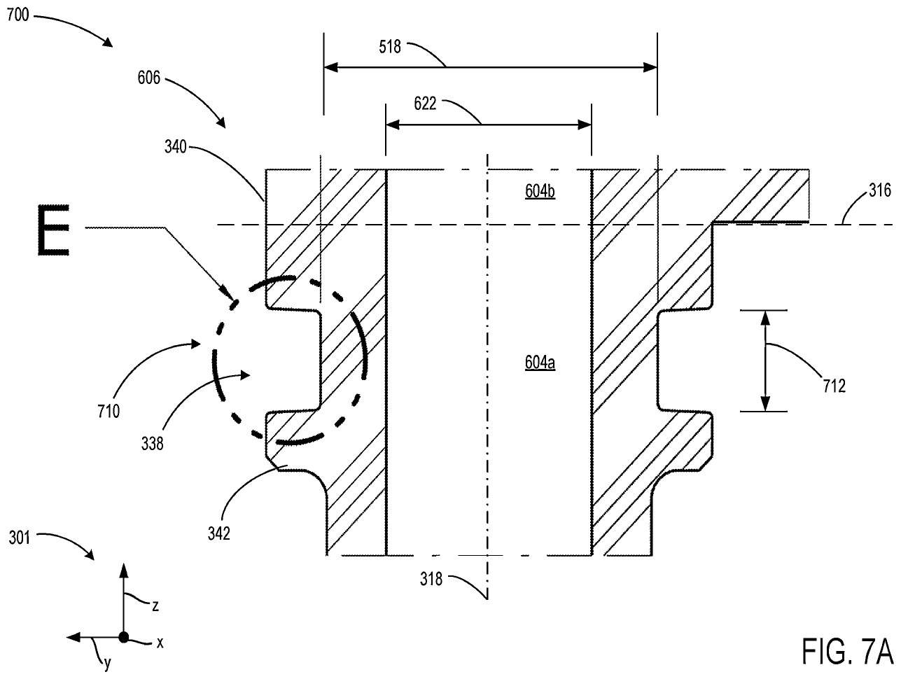

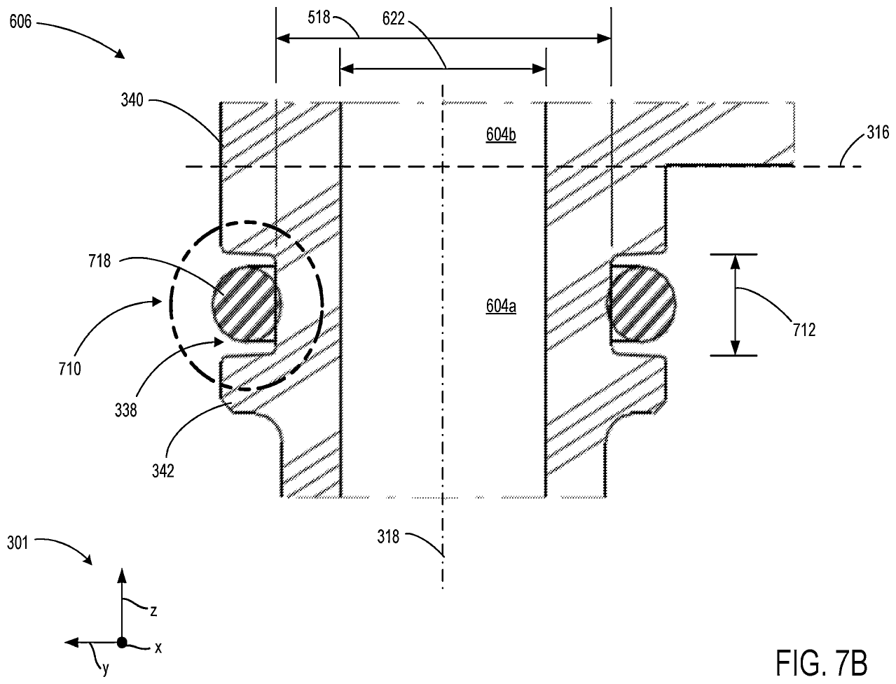

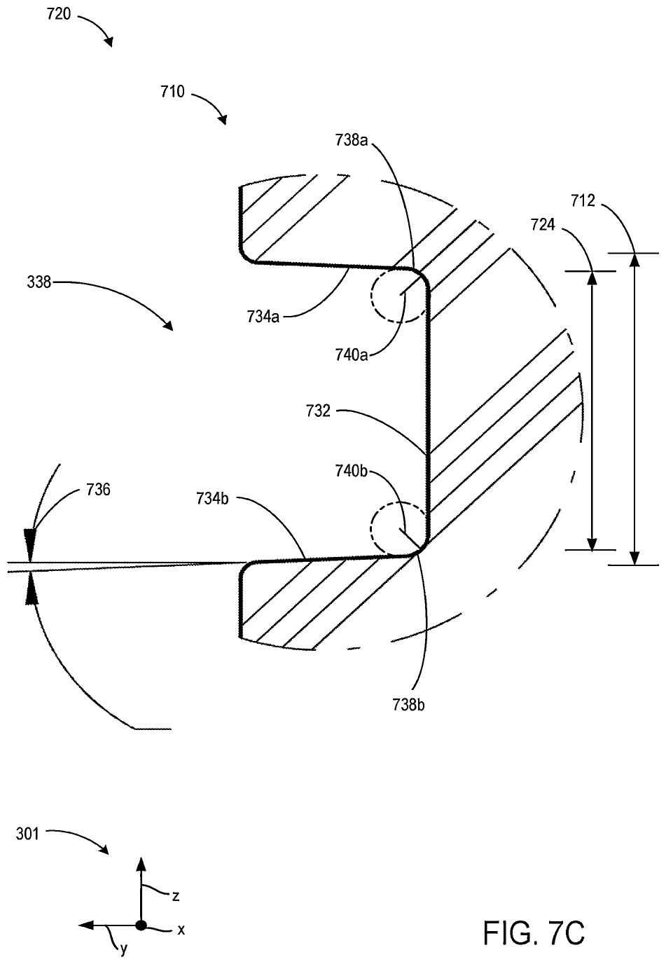

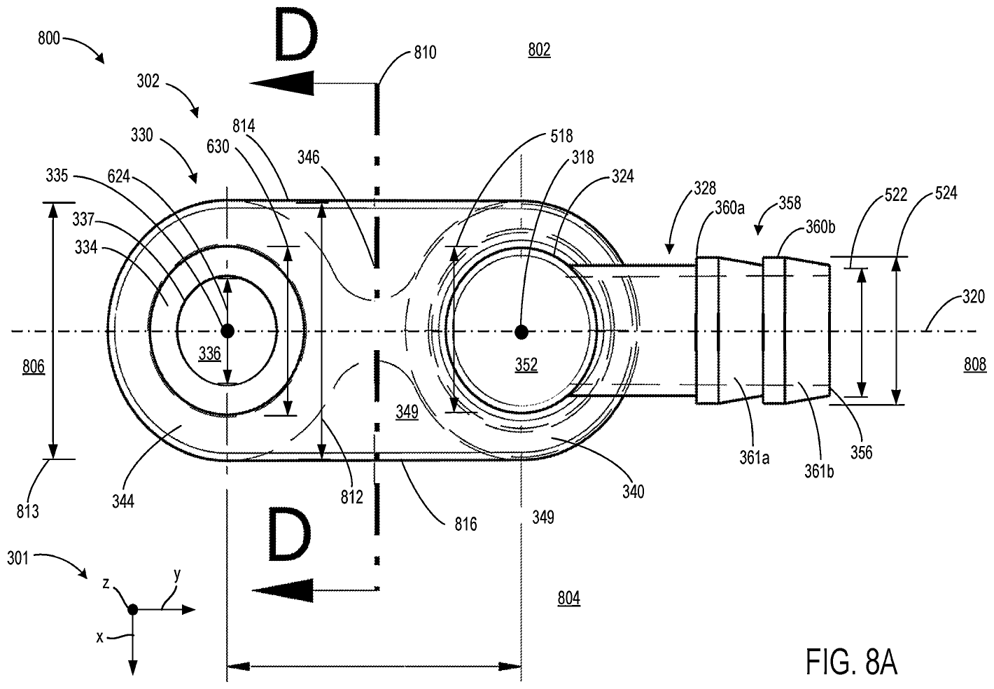

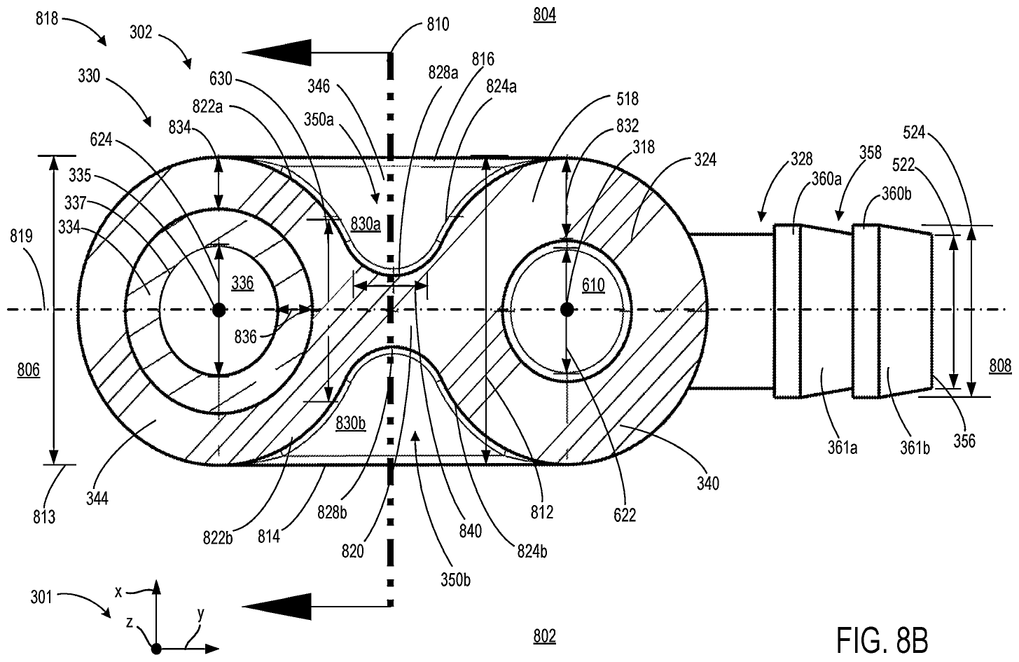

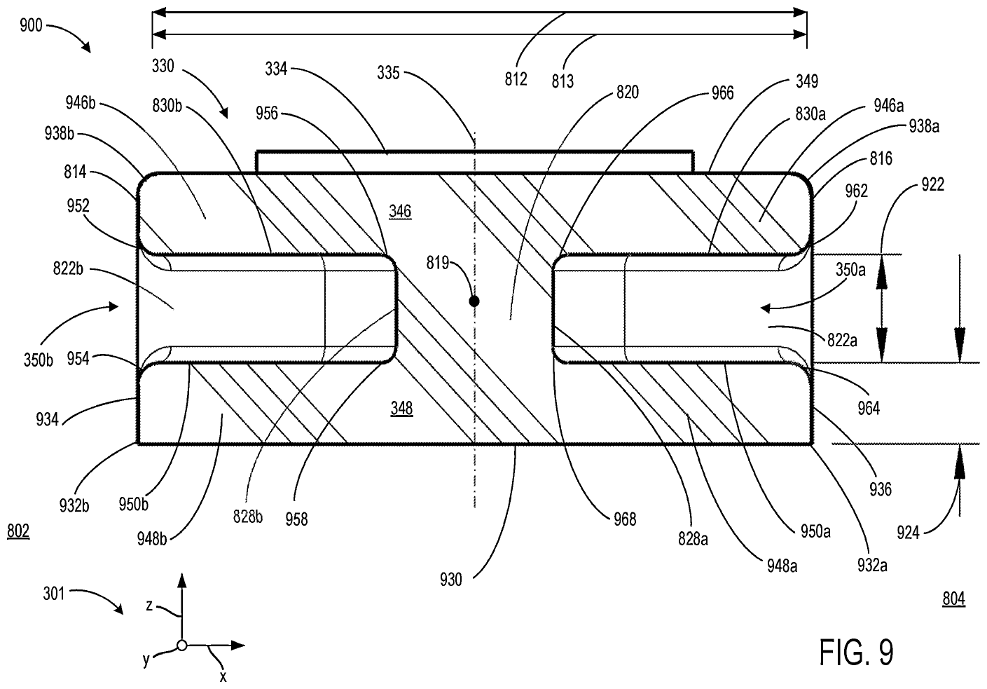

A schematic of a vehicle is shown with a transmission that may contain an example gear box of the present disclosure as well as components, such as the wheels, the gear box may affect in FIG. 1. A schematic of an enclosure within the transmission and a gear box is shown in FIG. 2. The schematic of FIG. 2 also shows a schematic of a vent of the present disclosure that may be fluidly coupled to the enclosure. FIGS. 3-6 and FIGS. 8A-B show an example embodiment of the vent isolated from other components. FIGS. 7A-C and FIG. 9 show sections of the example embodiment of the vent. FIG. 3 shows an example embodiment of the vent of FIG. 2 from a first perspective view. FIG. 3 shows the vent may be formed of a first portion, a second portion, and a fastening portion. FIG. 4-5 shows the example embodiment of the vent from a first side view and a second side view, respectively. FIG. 4-5 show dimensions, such as the heights and diameters, of components and features of the vent. FIG. 6 shows a first sectional view of the vent and features such as interiors and passages. FIG. 6 shows additional dimensions such as diameters, heights, lengths, and other distances of features of the vent. FIG. 7A-B show a second sectional view of a first area isolated from other features of the vent. FIG. 7B shows the first area of the vent with sealing member about a groove of the vent. FIG. 7C shows a second area of the vent isolated from other features of the first area. FIG. 7C shows additional features of the groove. FIG. 8A shows a third side view taken from above the vent. FIG. 8B shows a third sectional view taken from below the vent. FIG. 9 shows a fourth sectional view of a third area of the vent. FIG. 9 shows additional details of features of the fastening portion.

It is also to be understood that the specific assemblies and systems illustrated in the attached drawings, and described in the following specification are exemplary embodiments of the inventive concepts defined herein. For purposes of discussion, the drawings are described collectively. Thus, like elements may be commonly referred to herein with like reference numerals and may not be re-introduced. FIGS. 1-2 show schematics of example configurations with relative positioning of the various components. Herein, when the vehicle is positioned on level ground, vertical is shown with respect to gravity. FIGS. 3-9 are shown approximately to scale, although other relative dimensions may be used. As used herein, the terms “approximately” is construed to mean plus or minus five percent of the range unless otherwise specified.

Further, FIGS. 1-9 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of the element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. Moreover, the components may be described as they relate to reference axes included in the drawings.

Turning to FIG. 1, an example vehicle 5 is shown. The vehicle 5 may have a front end 100 and a rear end 102, and may be bisected into two approximately symmetrical halves by a longitudinal axis 104.

In some examples, vehicle 5 may be a hybrid vehicle with multiple sources of torque available to one or more vehicle wheels 55. Alternatively, the vehicle 5 may include solely an internal combustion engine. In other examples, vehicle 5 may be an all-electric vehicle, powered exclusively by an energy storage device such as a battery 58.

In the example shown, vehicle 5 includes a prime mover 52. In one example the prime mover 52 may be an engine, such as an internal combustion engine. For this example, the prime mover 52 may receive a fuel such as gasoline or diesel to combust, converting chemical energy from the fuel into rotational energy.

In other examples the prime mover 52 may be an electric machine which may be an electric motor, an electric motor/generator, or an electric motor/engine. The prime mover 52 may receive electrical power from the battery 58 which is converted to rotational energy, e.g., torque, at a transmission 56. The transmission 56 may be a planetary transmission with a gearset with at least one sun gear surrounded by and meshed with a plurality of planet gears. The torque may be delivered to vehicle wheels 55, which includes a set of front wheels proximate to a front end 100 of vehicle 5 and a set of rear wheels proximate to a rear end 102 of vehicle 5. Prime mover 52 may also be operated as a generator to provide electrical power to charge the battery 58, for example, during a braking operation.

FIG. 1 shows an embodiment prime mover 52 provides rotational energy to the wheels of vehicle 5 via the transmission 56. The wheels 55 may be drivingly coupled to the vehicle 5 and or transmission via a first axle 62 and a second axle 64. For this example, the embodiment of vehicle 5 has the first axle 62 proximate to the front end 100 and the second axle 64 proximate to the rear end 102 of vehicle 5. For this example, the embodiment of vehicle 5 has a prime mover 52 and the transmission 56 closest to the front end 100 of vehicle 5. A gear box 70 is incorporated into the transmission providing the transmission with different gears to select via a clutch. For this example, the prime mover 52 and transmission 56 may provide rotational energy to a drive shaft 72 to transfer rotational energy to a differential 68 to rotate the wheels 55 closest to the rear end 102. It will be appreciated that in other examples, rotational energy may be alternatively provided to the wheels 55 located near the front end 100 of vehicle 5. Furthermore, in other examples, each of the wheels 55 near the front end 100 and the wheels 55 near the rear end 102 may be coupled to individual transmissions, such as when vehicle 5 is configured with all-wheel drive. As well, in other embodiments, transmission 56 and/or prime mover 52 may be arranged closer to the rear end 102 of vehicle 5 rather than the front end 100.

The battery 58 may be between the vehicle wheels 55 and closer to the rear end 102 of vehicle 5 than the front end 100. For example, the battery 58 may be positioned below rear passenger seats of the vehicle. In another example, the battery 58 may be located in a floor of a rear compartment of the vehicle or may be integrated into a vehicle chassis. In other examples, however, the battery 58 may be located in a different relative position within vehicle 5 than shown in FIG. 1.

Turning to FIG. 2 a schematic 200 of the transmission 56 and gear box 70 are shown with a vent 202. Above the transmission 56 is the first axle 62. The first axle 62 may be drivingly coupled to the transmission 56. The vent 202 may be passed through a first hole 204 in a housing 205 of the transmission 56 and a second hole 206 in a housing 207 of the gear box 70. A gear assembly 208 may be located in an enclosure 210 formed by the gear box 70. For the example in FIG. 3, the housing 207 may act as a housing for the enclosure 210. For the example in FIG. 3, the housing 205 of the transmission 56 may act as an additional housing surrounding the enclosure 210 and gear box 70. The vent 202 may be fluidly coupled to the enclosure 210. The vent 202 may be coupled, such as through mounting, to housing 207. However, it is to be appreciated that the location and formation of an enclosure may be non-limiting. Vent 202 may be used in other enclosures, such as enclosures formed by an engine housing, a gas tank, an emission treatment device, or a battery housing.

The gear assembly 208 may circumferentially surround and drivingly coupled a shaft 212. The shaft 212 may drivingly couple the gear assembly 208 to the prime mover 52. For one example the shaft 212 may be an output shaft of the prime mover 52.

The vent 202 may be centered and aligned on axis 218, wherein the vent 202 may be located about the axis 218. The axis 218 may be vertical, wherein the axis 218 is approximately parallel with the direction of gravity 220. The shaft 212 may be centered and aligned on axis 221, wherein shaft 212 may be located about an axis 221, wherein the shaft 212 may circumferentially surround and have lengths collinear with the axis 221. The axis 221 may be longitudinal relative to the transmission 56, gear box 70, and vehicle 5, wherein the axis 221 is approximately perpendicular to the direction of gravity 220.

Features described as axial may be approximately parallel with an axis unless otherwise specified. Features described as lateral may be approximately perpendicular to an axis unless otherwise specified. The central axis 221 is longitudinal with respect to and therein may act as a longitudinal axis for the gear assembly 208, gear box 70, and transmission 56. With respect to a longitudinal axis, such as the central axis 221, features described as longitudinal may be approximately parallel to a longitudinal axis. Features that may circumferentially surround or extend from a longitudinal axis may be described as radial.

The enclosure 210 may form a sump 217 filled with lubricant 216, such as oil. The sump 217 and lubricant 216 may be located below the gear assembly 208 relative to the axis 218. The lubricant 216 may lubricate the gears, shafts, clutches, and other mechanical components of the gear assembly 208. Lubrication may reduce friction and mitigate temperature for the gear assembly 208. During operation, gases 214, such as emissions, may accumulate in the enclosure 210 above and around the gear assembly 208. During operations, thermal energy may accumulate in the gases 214 increasing the temperature and placing pressure on the enclosure 210 and gear box 70. The vent 202 may be used to mitigate the temperature and pressure of the enclosure 210 by removing gases 214.

The vent 202, may be formed of a first portion 222 and a second portion 224. The first and second portions 222, 224 are hollow and may form a passage 226. The first and second portions 222, 224 may act as a first hollow portion and a second hollow portion, respectively. Axis 218 may act as a single, straight, and central axis for the first portion 222 and passage 226. The passage 226 may be fluidly coupled and in fluid communication with the enclosure 210.

An extension 228 of the second portion 224 and a fastening portion 230 may extend radially from the vent 202, with respect to the axis 218. The extension 228 is conduit that may be formed of the second portion 224 and is fluidly coupled to the passage 226. The extension 228 of the second portion 224 may act as a third hollow portion for the vent 202 in fluid communication with the first and second portions 222, 224. The extension 228 may extend radially and perpendicularly with respect to the axis 218 and the passage 226. As an example of one embodiment, fastening portion 230 may extend and be formed from the first portion 222. However, it is to be appreciated that for other embodiments the fastening portion 230 may be formed and extend from the second portion 224.

The vent 202 may be mounted to an outer surface of a gear box housing 207 via the fastening portion 230 and a fastener 236. Vent 202 may therein be a mountable vent. The fastening portion 230 may include or be a flat extension. The fastening portion 230 may contain a compression limiter 234 about a third hole 232. The compression limiter 234 may be formed of a material that is more rigid and higher strength, such as a metal, than the material of the vent 202. The compression limiter 234 may be formed and molded-in in the material of the fastening portion 230. The compression limiter 234 may be molded-in the flat extension of the fastening portion 230. The compression limiter 234 abut an outer surface of a housing. For schematic 200, compression limiter 234 may abut the outer surface of gear box housing 207. For schematic 200, the compression limiter 234 may abut the top surface of the gear box housing 207, relative to gravity 220. An inner surface of a housing may abut the compression limiter 234. For schematic 200, an inner surface of transmission housing 205 may abut the compression limiter 234. For schematic 200, the inner surface of transmission housing 205 may be located above the compression limiter 234 relative to gravity 220.

For the example shown in schematic 200, the fastening portion 230 and compression limiter 234 may be located above and abut a surface of the gear box 70, wherein the fastening portion 230 may be positioned above a fourth hole 242. The fastening portion 230 and compression limiter 234 may have face sharing contact with the gear box 70. The fastening portion 230 may be aligned with the gear box 70, such that a central axis 231 may be approximately concentric to and circumferentially surrounded by the third hole 232 and fourth hole 242.

At least one fastener, such as a fastener 236, may be used to attach the vent 202 via the fastening portion 230 to a housing, such as the gear box housing 207. For one embodiment, the fastener 236, such as a bolt, may be inserted through the fastening portion 230 and fourth hole 242 to fasten the fastening portion 230 to the gear box housing 207. The fastener 236 may be inserted through the fastening portion 230 and a hole similar to fourth hole 242 to fasten the fastening portion 230 to another enclosure. The third hole 232 and fourth hole 242 may have a first surface 235 and a second surface 243, respectively. The first surface 235 and second surface 243 may be located within the diameter of the respective holes, therein the first surface 235 may be referred to as first inner surface 235 and the second surface 243 may be referred to as a second surface 243. Both the first inner surface 235 and second inner surface 243 may be cylindrical in shape and circumferentially surround central axis 231. The fastener 236 may be in face sharing contact with the first inner surface 235 and/or the second inner surface 243.

The first portion 222 may have a groove 238. A sealing member 240 may be positioned about the groove 238. The sealing member 240 may abut the surfaces of the second hole 206. Gases 214 may be removed from the enclosure 210 through the passage 226 of the vent 202. Gases 214 in the enclosure 210 may enter the vent 202 at inlet 244 on the first portion 222. Gases 214 may exit the vent 202 at outlet 246 on extension 228. Gases 214 may exit the enclosure 210 along a path 250.

The first portion 222 and hole 206 may extend through a wall 254 to the enclosure 210. The wall 254 may be a housing wall for the gear box housing 207 and may provide a surface for which the fastener 236 and the fastening portion 230 may be coupled to. The fourth hole 242 may partially extend through the housing wall 254. The wall 254 may have a thickness 256. Thickness 256 of the wall may be referred to herein as a housing wall thickness 256. For schematic 200, housing wall 254 may form the top of the housing 207 and with a surface perpendicular relative to gravity 220. However, it is to be appreciated that the location of the housing wall 254 may be non-limiting. For example, housing wall 254 may form the bottom wall with a surface perpendicular relative to gravity 220. For another example, housing wall 254 may form a side wall or another component with a surface parallel relative to gravity.

The second hole 206 may have a length approximately the same distance as thickness 256, wherein length is the distance along a central axis relative to the fourth hole 242. The fourth hole 242 may have a length that may be less than the thickness 256, wherein length is the distance along a central axis relative to the fourth hole 242.

To install the vent 202 into an enclosure, the first portion 222 may be passed into a hole. The hole that acts as a receiving opening for the first portion 222. Through the hole, the first portion 222 may be passed into and or fluidly couple an enclosure. The fastening portion 230 may also be fastened to a housing via a surface and a fastener. The vent 202 may be fastened against at least a housing of the enclosure. The vent 202 may be installed by hand at any point the assembly process for the enclosure and the housing of the enclosure.

For the example in schematic 200, the hole and receiving opening may be the second hole 206, the housing may be the gear box housing 207, and the enclosure may be enclosure 210. For the example shown in schematic 200, the vent 202 may be installed by passing the first portion through the first and second holes 204, 206, and a section of the second portion 224 may be passed through the first hole 204. The second hole 206 may be located in a housing for an enclosure, such as gear box housing 207 for an enclosure 210. The first hole 204 is located in a second housing, such as a transmission housing 205.

However, it is to be appreciated that for other embodiments there may be a single housing for an enclosure. For example, there may be an embodiment of an enclosure enclosed by a single housing. For this example, the first portion 222 may be passed and extend through a first hole in the housing, and the second portion 224 may extend above the housing.

It is also to be appreciated, that there may be a plurality of housings around an enclosure. For example, there may be an embodiment of an enclosure enclosed by a plurality of housings. For this example, the first portion 222 may be passed through a hole for each housing surrounding the enclosure, with an inner housing and an outer housing, wherein the inner housing is located closest to the enclosure and the outer housing is located furthest from the enclosure, respectively. The first portion 222 may extend through a plurality of holes of a plurality of housings surrounding the enclosure. The first portion 222 may extend through a hole in the innermost enclosure. The second portion 224 may be passed through and extend through a plurality of holes of a plurality of housings surrounding the enclosure. The second portion 224 may extend through and/or above the outermost enclosure. The second portion 224 may be fluidly coupled to another fluid carrying component, wherein the fluid carrying component may be a sealed fluid tight body, such as a vent, duct, hose, a flue, a pipe, a reservoir, or another enclosure, that may extend through and above the outermost housing.

The compression limiter 234 may transfer compressive force and other mechanical forces from the transmission 56 to the gear box 70 and away from the material of the vent 202. The compression limiter 234 may also provide compressive resistance against the fastener 236, and transfer compressive and other mechanical forces from the fastener 236 to the gear box 70. For example, the fastener 236 may have a head 262. The head 262 may abut and have face sharing contact with an exposed surface 264 of the compression limiter 234.

The compression limiter 234 may prevent degradation to the vent 202 due to over torqueing of the fastener 236. The fastener 236 may be passed through the third hole 232 and fourth hole 242. The fastener 236 may have connectable interaction devices, such as a threading, complementary to connectable interaction devices on at least the fourth hole 242. The fastener 236 may also have a connectable interaction devices complementary to connectable interaction devices on the third hole 232. Connectable interaction devices may be formed from and/or located on the first inner surface 235 and be about the third hole 232. Connectable interaction devices formed from and/or located on the second inner surface 243 and be about the fourth hole 242. When components and/or features are coupled via connectable interaction devices, the components and/or features may be referred to herein as threaded. When threaded with and through at least the fourth hole 242 and extended through the third hole 232, the fastener 236 may fasten and/or couple the fastening portion 230 and vent 202 to the gear box 70. When threaded with and through the third hole 232 and fourth hole 242, the fastener 236 may fasten and/or couple the fastening portion 230 and vent 202 to the gear box 70. When fastened and/or coupled to the third hole 232 and/or fourth hole 242, the fastener 236 may be in face sharing contact with the features of the third hole 232 and/or fourth hole 242, such as the first inner surface 235 and second inner surface 243. The install and coupling of the fastening portion 230 may be completed with a final torque to the fastener 236. Coupling the fastening portion 230 to the gear box housing 207 may mount the vent 202 to the gear box 70. The fastening portion 230 may be fastened via fastener 236 to a hole approximately the same or similar in dimensions to and the connectable interaction of to fourth hole 242. Vent 202 may therein, be mounted on a housing with a hole approximately the same or similar in dimensions to and the connectable interaction of fourth hole 242 via the fastening portion 230 and fastener 236.

The head 262 may apply a compressive force against the exposed surface 264. The connectable interaction devices of the fastener 236 may apply a compressive force to the complementary to connectable interaction devices of the first and/or second inner surfaces 235, 243. The compressive forces of the head 262 and complementary connectable interaction devices of the fastener 236 may be referred to individually or collectively as compressive forces 266. The compressive forces 266 may extend through the material of compression limiter 234 to the gear box housing 207. The compressive forces 266 may be greater than the force of gravity 220. The fastener 236 may therein keep the fastening portion 230 and vent 202 coupled to the gear box housing 207 when the direction of gravity 220 is opposite to the compressive forces 266. The fastener 236 may therein keep the fastening portion 230 and vent 202 coupled to a housing of another enclosure compatible with the fastener 236 and fastening portion 230 when the direction of gravity 220 is opposite to the compressive forces 266.

The fastening portion 230 and fastener 236 may prevent the vent 202 from becoming detached from the gear box housing 207 if the sealing member 240 experiences degradation. For example, the fastening portion 230 and fastener 236 may prevent the vent 202 from becoming detached from the gear box housing 207 if components and features of the vent 302 experience degradation. When the fastening portion 230 and vent 202 are coupled, the gear box 70, the vent 202 or portions of the vent 202 may be prevented from abutting a housing 260 of or other features of the first axle 62. Additionally, with reference to FIG. 1, when fastening portion 230 and vent 202 are coupled the gear box 70, the vent 202 may be prevented from abutting components and/or features of a second axle 64. Additionally, with reference to FIG. 1, when fastening portion 230 and vent 202 are coupled the gear box 70, the vent 202 may be prevented from abutting components and/or features of a driveline, such as drive shaft 72 or differential 68. For this or other examples, if the vent 202 is formed of plastic, fiberglass, and/or another non-metal material, deformation due to brittleness may be prevented. For these examples, the vent 202 may be prevented from separating into portions or degradation. For these examples with reference to FIG. 1, the components of or the vent 202 may be prevented from abutting components and/or features of the first axle 62, second axle 64, differential 68, and or drive shaft 72.

The sealing member 240, such as an O-ring, may be detachable from the vent 202 and may be removed from the groove 238. The sealing member 240 may be removed from the groove 238 without causing degradation to the sealing member 240 or the vent 202. The sealing member 240 may be elastic and ring like in shape. The elasticity of the sealing member 240 allows the sealing member 240 to be compressed so the first portion 222 may be translated axially through the second hole 206 with deliberate force. The elasticity of the sealing member 240 may allow the sealing member 240 to expand to abut and form a seal against the surface of the second hole 206.

A seal formed by the sealing member 240 may be at least liquid tight and may be air tight. The sealing member 240 may prevent lubricant 216 from exiting the enclosure 210. The seal created by the sealing member 240 may prevent gases 214 from exiting the enclosure 210 without passing through the passage 226 of the vent 202.

For the example in FIG. 2, gases 214 traveling on path 250 may enter the first portion 222 of the enclosure 210 via an inlet 244. After entering the first portion 222, gases may travel axially, with respect to the axis 218, the passage 226. On path 250, gases 214 may exit the gear box 70 in the section of the passage 226 surrounded by the first portion 222. On path 250, gases 214 may exit the transmission 56 in the section of the passage 226 surrounded by the second portion 224. At the mouth 248 of the extension 228, the path 250 may change directions. Above the mouth 248 is an end 252 on the second portion 224. The end 252 may be closed preventing gases in the passage 226 from moving along the axis 218. Gases 214 on path 250 may exit the passage 226 and enter extension 228 through mouth 248, wherein the path 250 may change directions from axial to radial, with respect to the axis 218. Gases on path 250 may exit the extension 228 and vent 202 via outlet 246. For one example gases may leave the outlet 246 to an area surrounding the vehicle 5. For another example, the outlet 246 may be fluidly coupled and in fluid communication with another fluid tight body, such as a vent, duct, hose, a flue, a pipe, a reservoir, or enclosure. For this example, these other bodies may be used to remove, store, or process gases 214.

A set of reference axes 301 are provided for comparison between views shown in FIG. 3-9. The reference axes 301 indicate a y-axis, an x-axis, and a z-axis. In one example, the z-axis may be parallel with a direction of gravity and the x-y plane may be parallel with a horizontal plane that a vent 302 may rest upon. When referencing direction, positive may refer to in the direction of the arrow of the y-axis, x-axis, and z-axis and negative may refer to in the opposite direction of the arrow of the y-axis, x-axis, and z-axis. A filled circle may represent an arrow and axis facing toward, or positive to, a view. An unfilled circle may represent an arrow and an axis facing away, or negative to, a view.

Turning to FIG. 3, it shows a first perspective view 300 of a vent 302. Vent 302 may be an embodiment of vent 202 with reference to FIG. 2.

A dividing plane 316 divides the vent 302 into a first portion 322 and a second portion 324, wherein the second portion 324 is located above the first portion 322. Vent 302 may be aligned with first axis 318, such that features of the first and second portions 322, 324 may extend along and be located about the first axis 318. A second axis 320 may extend radially with respect to the first axis 318. An extension 328 of the second portion 324 may extend along and be located about the second axis 320. The first portion 322 and second portion 324 may be the same or similar to first portion 222 and second portion 224, respectively, with reference to FIG. 2. The first axis 318 may be the same or similar to axis 218, with reference to FIG. 2.

The first portion 322 and second portion 324 may be coupled at the dividing plane 316. The dividing plane 316 may be formed on lines approximately parallel with the x and y axes. A fastening portion 330 may extend radially from the vent 302 with respect to the first axis 318. The fastening portion 330 may be or contain a flat extension with a single or a plurality of surfaces, such as a surface 349, parallel with the dividing plane 316. As an example, the dividing plane 316 shown in perspective view 300 may be located below the fastening portion 330. For this example, the fastening portion 330 may extend and be formed from second portion 324. The first portion 322 may be located below the fastening portion 330.

For another example, the dividing plane 316 may be located above the fastening portion 330. For this example, the fastening portion 330 may extend and be formed from first portion 322. The second portion 324 may be located above the fastening portion 330.

The second portion 324 may be formed of a second conduit 326 and an extension 328. Extension 328 may be the same or similar to extension 228, with reference to FIG. 2. The second conduit 326 and extension 328 may be hollow and fluidly coupled to one another. The second conduit 326 may be located about the first axis 318. The second conduit 326 may circumferentially surround the first axis 318. The extension 328 may be located about the second axis 320. The extension 328 may circumferentially surround the second axis 320. The extension 328 extends radially and perpendicularly with respect to the first axis 318. The second conduit 326 and extension 328 may have portions that are approximately cylindrical in shape.

The first portion 322 may be formed of a first conduit 332. The first conduit 332 may be located about the first axis 318. The first conduit 332 may circumferentially surround the first axis 318. A groove 338 may be located about the first conduit 332 and below the fastening portion 330. On one side of the groove 338 may be a fastening portion, such as fastening portion 330; on the opposite side of the groove 338 may be a land, such as first land 342. For the embodiment shown in vent 302, above the groove 338 may be a first column 340 that is part of the fastening portion 330. Below the groove 338 may be a first land 342. The first column 340 and first land 342 may be located about the first axis 318. The first column 340 and first land 342 may circumferentially surround the first axis 318. The first conduit 332 may have portions that are approximately cylindrical in shape.

A compression limiter 334 may be surrounded and partially enclosed by the material of the fastening portion 330. The compression limiter 334 may be located about and partially surround a third axis 335 approximately parallel to the first axis 318. The third axis 335 may be the same or similar to the central axis 231. The compression limiter 334 may form and be located about a hole 336 in the fastening portion 330. A second column 344 surrounds and partially encloses the compression limiter 334. The first column 340 and second column 344 may be cylindrical in shape, acting as a first cylinder and second cylinder, respectively, for supporting and forming the fastening portion 330. The first column 340 may support and join the fastening section to the first and second portions 322, 324 of the vent. The second column 344 may support the compression limiter 334. The second column 344 may be joined to the first column 340 to form the fastening portion 330. The first and second columns 340, 344 may be joined via a first platform 346 and a second platform 348. The first platform 346 and second platform 348 may be semi rectangular in shape. The first and second platforms 346, 348 may conform and have areas that curve about and join at the circumferences of the first and second columns 340, 344.

Between the first platform 346 and second platform 348 may be a volume 350. From perspective view 300 volume 350 may appear as a recess in the fastening portion 330 located between the first platform 346 and second platform 348 and between the first column 340 and second column 344. Volume 350 may be formed by plurality of recesses partially enclosed by the first platform 346, the second platform 348, the first column 340, and the second column 344. The first platform 346 may be located above the volume 350 and the second platform 348 may be located below the volume 350. The first and second platforms 346, 348 may be joined and supported vertically, relative to the first axis 318, by material of the fastening portion 330 (e.g., rib 820 in FIG. 8B). The volume 350 may be divided into first side and second side symmetric volumes (e.g., the first volume 350a and second volume 350b) by the second axis 320. The first platform 346 may have a surface 349 facing upward. The surface 349 may not be enclosed by or face volume 350, and therein may be referred to as a first outer surface 349. The volume 350 may reduce the weight of and material used to manufacture the vent 302.

The compression limiter 334 forms a surface 337 about the axis 335 and the hole 336. Surface 337 is formed at the circumference of the hole 336 and an inner circumference of the compression limiter 334, the surface 337 may therein be referred to as inner surface 337. The compression limiter 334 and hole 336 may be an embodiment of and function the same or similar to the compression limiter 234 and third hole 232, respectively, with reference to FIG. 2. The inner surface 337 may therein be the first inner surface 235 of third hole 232. A fastener, such as fastener 236 with reference to FIG. 2, may be inserted through hole 336 into a complementary hole that may be an embodiment of or the same or similar in function to fourth hole 242 of FIG. 2. The fastener may be used to couple the compression limiter 334, fastening portion 330, and vent 302 to a surface of enclosure housing with a complementary hole to fastener 236. Connectable interaction devices, such as threading, may be coupled to or formed from the inner surface 337. Connectable interaction devices of inner surface 337 may be complementary to connectable interaction devices formed on or coupled to the surface of a fastener.

The top 352 of the second conduit 326 may be a closed surface. The bottom of the first conduit 332 may have an inlet 354. The extension 328 has an outlet 356. A port 358 may be formed from the extension 328 and be located about the outlet 356. The port 358 may be used to fluidly couple the extension 328 and vent 302 to a port or fitting of another sealed fluid tight body, such as a vent, duct, hose, a flue, a pipe, a reservoir, or enclosure. The port may be formed of a plurality of lands. For an example of an embodiment, there may be a first land 360a and a second land 360b. The first and second lands 360a, 360b may form into a first shape 361a and a second shape 361b, respectively. The first shape 361a and second shape 361b may be semi-conical with diameters that decrease closer to the outlet 356, with respect to the second axis 320.

The top 352, inlet 354, and outlet 356 may function the same or similar to the end 252, inlet 244, and outlet 246, respectively, with reference to FIG. 2.

Turning to FIG. 4, it shows a first side view 400 of the vent 302. For the example in FIG. 4, the second axis 320 and x axis are positive ton and extending toward first side view 400. The vent 302 may be bisected by a line 406, which may be referred to herein as line A 406. Line A 406 may be approximately parallel with the first axis 318. The line A 406 and a line parallel with z-axis may form a plane that divides vent 302 into two symmetrical halves. A cross section (e.g., first sectional view 600 in FIG. 6), may be taken on line A 406. The vent 302 may have a height 410 that is approximately parallel with line 406 and first axis 318. The height 410 extends axially, with respect to the first axis 318, from the inlet 354 to the top 352.

Port 358 may circumferentially surround the second axis 320, outlet 356, and extension 328. The outlet 356 and extension 328 may circumferentially surround the and form an inner surface 420 that is approximately cylindrical. The inner surface 420 may be approximately circular in shape from the perspective of first side view 400.

Turning to FIG. 5, shows a second side view 500 of the vent 302. Second side view 500, shows the fastening portion 330 may be divided by a line C 504, referred to herein as a line C 504. A sectional view (sectional view 818) may be taken on the line C 504 for FIG. 8B. The second side view 500 shows a plurality of outer diameters, heights, and axes of various features of the vent 302.

For this example, the first portion 322 has a first height 506, the second portion 324 has a second height 508, and the fastening portion 330 has a third height 510. The first height 506, second height 508, and third height 510 are approximately parallel with the first axis 318. Additionally, for an example, first height 506, second height 508, and third height 510 may be vertical and approximately parallel with respect to the z-axis. The first height 506 extends the distance of the first portion 322 from the inlet 354 to the dividing plane 316. The second height 508 extends the distance of the second portion 324 from the dividing plane 316 to the top 352. The third height 510 extends from a surface 530 of the of the second platform 348 to the first outer surface 349 to the second platform 348. Surface 530 may face downward. The surface 349 may not be enclosed or facing volume 350, and therein may be referred to as a second outer surface 530. For the example FIG. 3, the fastening portion 330 extends radially from the second portion 324 and the second height 508 contains third height 510. For other examples where the fastening portion 330 extends radially from the first portion 322, the first height 506 may contain third height 510.

The first column 340 and first land 342 may share a first outer diameter 512. The cylindrical portions of the first conduit 332 may have a second outer diameter 514 that is smaller compared to the first outer diameter 512. The cylindrical portions of the second conduit 326 may have a third outer diameter 518. For an example of one embodiment of the vent 302, the third outer diameter 518 may be smaller compared to the second outer diameter 514.

The extension 328 may have a fourth outer diameter 522. The extension 328, outlet 356, and a notch 528 may share the fourth outer diameter 522. The notch 528 may be located between the first shape 361a and the second land 360b. The first and second lands 360a, 360b may have a fifth outer diameter 524. The fifth outer diameter 524 may be larger compared to the fourth outer diameter 522. The first shape 361a may have a diameter that decreases from the distance of the fifth outer diameter 524 to the fourth outer diameter 522 between first land 360a and notch 528. The second shape 361b may have a diameter that decreases from the distance of the fifth outer diameter 524 to the fourth outer diameter 522 between second land 360b and outlet 356. The extension 328 is of a length 532. Length 532 stretches axially with respect to the second axis 320 from the third outer diameter 518 to the outlet 356 of the extension 328.

FIG. 5 also shows an offset 555 below a bottom surface of the bottom platform relative to one end of the seal groove. For the embodiment of vent 302, the offset 555 may extend from the top of the groove 338 and bottom of the first column 340 to the bottom surface of the second platform 348. The first platform 346 and second platform 348 are spaced away from the seal by at least the offset 555. Offset 555 may completely separate the first platform 346 and second platform 348 from the seal.

Turning to FIG. 6, it shows a first sectional view 600 of the vent 302. View 600 is taken on the line A 406 with reference to FIG. 4. First sectional view 600 show features of the interior of the vent 302 such as inner diameters, passages, and surfaces. The first sectional view 600 shows an area 606, that may be referred to herein as area B 606. The first and second portions 322, 324 may form a first passage 604 for the vent 302. A second passage 610 may be formed and enclose by extension 328. The first passage 604 and second passage 610 may be fluidly coupled and in fluid communication at a mouth 608. The first passage 604 may be fluidly coupled and in fluid communication with the inlet 354. The second passage 610 may be fluidly coupled and in fluid communication with the outlet 356. Area B 606 encloses the groove 338 and the first land 342. Likewise, area B 606 encloses a portion of second column 344 and a portion of the first passage 604 extending through the vent 302. The first passage 604 may be and function the same or similar to the passage 226 with reference to FIG. 2. Mouth 608 may be and function the same or similar to mouth 248 with reference to FIG. 2. The passage 604 may be divide into at least two sections: a first section 604a formed by the first portion 322 and a second section 604b formed by the second portion 324.

For example, the embodiment of vent 302, the first passage 604 may extend axially with the first axis 318 from the inlet 354 to a surface 616 of the top 352. The surface 616 may be enclosed by the vent 302, and may be referred to herein as the inner surface 616. The second passage 610 For this example, the second passage 610 may extend axially with respect to the second axis 320 from the mouth 608 to the outlet 356. The first section 604a may have a height approximately the same as the first height 506. For this example, the second section 604b may have a fourth height 612. The fourth height 612 may extend axially with respect to the first axis 318 from the dividing plane 316 to the inner surface 616. The top 352 is of a thickness 614, wherein the thickness 614 is approximately parallel with the first axis 318. The fourth height 612 is approximately equivalent in distance to thickness 614 subtracted from the second height 508.

The first and second conduits 332, 326 have a first inner diameter 622. Likewise, the inner diameter 622 is approximately the diameter of passage 604. The extension 328 has a second inner diameter 626. The first inner diameter 622 may be continuous with the height 410 of the vent 302, and the second inner diameter 626 is continuous with the length 532 of the extension 328.

First sectional view 600 shows the compression limiter 334 may have a sixth outer diameter 630 and third inner diameter 624. First sectional view 600 also shows the compression limiter 334 may have a height 628 that may be larger and extend above third height 510 of the fastening portion 330. The compression limiter is also shown to have a land 632. The land 632 may extend radially, with respect to third axis 335, from the sixth outer diameter 630 of the compression limiter 334 into the material of the fastening portion 330. The land 632 may be used as an anti-pullout feature to prevent sliding or other movement of the compression limiter 334 along the third axis 335.

FIG. 7A-B shows second sectional view 700 of area B 606 from a closer perspective relative to first sectional view 600. Second sectional view 700 shows area B 606 isolated from other components of the vent 302. Enclosed by area B 606 is an area E 710. Area E 710 encloses a portion of the groove 338, first column 340, and first land 342. The groove 338 may have a height 712. Height 712 may be a maximum height of the groove.

FIG. 7A shows the area B 606 isolated. FIG. 7B shows the area B 606 with a sealing member 718 about the groove 338. The sealing member 718 may be and act as a seal, such as an O-ring. The sealing member 718 may be elastic and ring like in shape. The sealing member 718 may be the same or similar in function to sealing member 240 with reference to FIG. 2.

FIG. 7C shows a sectional view 720 of area E 710 isolated from area B 606. The sectional view 720 shows that portions of the groove 338 may be of a height 724, wherein height 724 is a minimum height for the groove 338.

Sectional view 720 shows the groove 338 may have a first surface 732, a second surface 734a, and a third surface 734b. The first surface 732 is parallel with the first axis 318 and may be vertical with respect to the z-axis. The height 724 is approximately the height of the first surface 732. The second and third surfaces 734a, 734b may extend radially with respect to the first axis 318. The second surface 734a may be above the third surface 734b. The second and third surfaces 734a, 734b may be separated by a maximum distance of height 712 and a minimum distance of height 724. The second surface 734a may be connected to the first surface 732 via a fourth surface 738a. The third surface 734b may be connected to the first surface 732 via a fifth surface 738b. Fourth and fifth surfaces 738a, 738b may be curved and share approximately the same or similar dimensions. For example, the fourth surface 738a may have a first radius 740a and the fifth surface 738b may have a second radius 740b, wherein the first and second radii 740a, 740b are approximately the same or similar distances. The third surface 734b may extend at an angle 736 from the first surface 732. The angle 736 may be between 0 and 5 degrees. Likewise, the second surface 734a may extend at an angle similar in dimensions to angle 736 from the first surface 732.

FIG. 8A shows a top view 800 of the vent 302. A line 810 divides the fastening portion 330 into two halves. To illustrate positioning, a set of sides have been labeled surrounding the vent 302. For example, the vent 302 may have a first side 802 and a second side 804 that are on opposite sides of the second axis 320. For this example, the vent 302 may have a third side 806 and a fourth side 808 on opposite sides of a line 810, referred to herein as the line D 810. The first side 802 may be in a negative direction from the vent 302, with respect to the x-axis. The second side 804 may be in a positive direction from the vent 302, with respect to the x-axis. The third side 806 may be in a negative direction from the vent 302, with respect to the y-axis. The fourth side 808 may be in a positive direction from the vent 302, with respect to the y-axis.

The first and second platforms 346, 348 may have a width 812. The width 812 may be parallel with the line D 810 and perpendicular to second axis 320. The width 812 may be approximately the same or similar distance as the first outer diameter 512 of the first column 340. The second column 344 has a diameter 813. The diameter 813 may be approximately the same or similar distance as the first outer diameter 512 and width 812.

The first platform 346 may have a first edge 814 located near and facing the first side 802 relative to the second axis 320. The first platform 346 may have a second edge 816 located near and facing the second side 804 relative to the second axis 320. The first and second edges 814, 816 are parallel with respect to the first axis 318 and may be vertical. The first and second edges 814, 816 may be approximately flat and parallel with planes formed by the y-z axes. FIG. 8B shows a fourth sectional view 818. Fourth sectional view 818 is taken on the line C 504. View shows additional detail of the first platform 346 from below. From the perspective of the fourth sectional view 818, the first and second sides 802, 804 appear flipped over the second axis 320 compared to top view 800. An axis 819 bisects the fastening section into two approximately symmetrical halves and divides the first and second sides 802, 804. Axis 819 may be parallel with second axis 320.

The fourth sectional view 818 shows the first inner diameter 622 and third inner diameter 624 may be approximately similar in distance. Between the first and second columns 340, 344 is a rib 820. The first platform 346 is located above the rib 820 and the second platform 348 is located below the rib 820. The rib 820 is surrounded by the volume 350 on each side. Volume 350 may be divided into a first volume 350a and a second volume 350b by the rib 820 of the fastening portion 330. The first volume 350a may be a recess formed between the first and second platforms 346, 348. The first volume 350a may be between the rib 820 and the second side 804. Second volume 350b may be a recess formed between the first and second platforms 346, 348. The second volume 350b may be between the rib 820 and the second side 804. First and second volumes 350a, 350b are volumes that are approximately symmetrical relative to the rib 820 and second axis 320.

The first column 340 and second column 344 may form into rib 820. A first surface 822a of the second column 344 may join to a third surface 828a of the rib 820 on the second side 804. A second surface 824a of the first column 340 may join into the third surface 828a on the second side 804. A fourth surface 822b of the second column 344 may join to a sixth surface 828b of the rib 820 on the first side 802. A fifth surface 824b of the first column 340 may join into the sixth surface 828b on the first side 802. The third surface 828a and sixth surface 828b may form the sides of the rib 820.

A surface 830a is located above the first volume 350a and a surface 830b is located above the second volume 350b, relative to axis 819. The surface 830a and surface 830b may be a part of the first platform 346. The surface 830a and surface 830b partially enclose the volume 350 and may be enclosed by the first platform 346 and second platform 348, and referred to herein as the first inner surface 830a and the second inner surface 830b, respectively.

Fourth sectional view 818 shows the first column 340 may be of a thickness 832 and the second column 344 may be of a thickness 834. The compression limiter 334 may be of a thickness 836. Thickness 832 may be greater than thickness 834, and thickness 832 may be approximately equal to sum of thickness 834 and thickness 836.

The rib 820 may have a length 840 that extends from the circumference of the first column 340 to the circumference of the second column 344. Length 840 may be parallel with axis 819.

FIG. 9 shows a fifth sectional view 900. Fifth sectional view 900 may be taken on line D 810.

The second platform 348 has a surface 930 located on the opposite side of axis 819 from surface 349. Surface 930 is an outer surface of the second platform and may be referred to herein as the second outer surface 930. Second outer surface 930 may be located on the bottom of the second platform 348, with respect to the first axis 218, and may act as a bottom surface for the fastening portion 330. The second outer surface 930 may abut a surface of a housing the fastening portion 330 is fastened to, such as the surface of a gear box housing, such as gear box housing 207.

The second platform 348 has a third edge 934 is located near and facing the first side 802, relative to the axis 819. Opposite to the third edge 934, is a fourth edge 936 located near and facing the second side 804 relative to the second axis 819. The third and fourth edges 934, 936 are parallel with respect to the axis 819 and first axis 318. The third and fourth edges 934, 936 may be approximately flat surfaces. The third and fourth edges 934, 936 may be approximately parallel with planes formed by the y-z axes and perpendicular to second outer surface 930. The third edge 934 and the fourth edge 936 may be similar in shape and dimensions and are parallel to first edge 814 and second edge 816, respectively.

The second outer surface 930 may have a fifth edge 932a and a sixth edge 932b that are not beveled. The fifth edge 932a may join the second outer surface 930 to the fourth edge 936 of the second platform 348. The sixth edge 932b may join the second outer surface 930 to the third edge 934 of the second platform 348.

The first outer surface 349 may be joined to the second edge 816 by a seventh edge 938a. The first outer surface 349 may be joined to the first edge 814 by an eighth edge 938b. The seventh and eighth edges 938a, 938b may be curved surfaces. The seventh and eighth edges 938a, 938b form bevels between the first outer surface 349 and the second and first edges 816, 814, respectively.

The first and second volumes 350a, 350b may have a height 922. The height 922 extends between the first platform 346 and second platform 348. The second platform 348 may be of a height 924. The first platform 346 may be a height approximately the same as height 924.

The first platform 346 has a first extension 946a that extends over the first volume 350a and a second extension 946b that extends over the second volume 350b. The second platform 348 has a third extension 948a that extends under the first volume 350a and a fourth extension 948b that extends under the second volume 350b. The first extension 946a, second extension 946b, third extension 948a, and fourth extension 948b may have a height 924.

The second platform 348 may have a surface 950a and a surface 950b that may be located below the first volume 350a and second volume 350b, respectively. The surface 950a and surface 950b partially enclose the volume 350 and may be enclosed by the first platform 346 and second platform 348, therein the surface 950a may be referred to as the third inner surface 950a and surface 950b may be referred to as the fourth inner surface 950b. The first inner surface 830a, second inner surface 830b, third inner surface 950a, and fourth inner surface 950b may be approximately parallel with one another. The first inner surface 830a and third inner surface 950a may be approximately co-planar. The second inner surface 830b and fourth inner surface 950b may be approximately co-planar.

The fastening section may have a plurality of connecting surfaces, such as first curved surface 952, a second curved surface 954, a third curved surface 956, a fourth curved surface 958, a fifth curved surface 962, a sixth curved surface 964, a seventh curved surface 966, and an eighth curved surface 968, respectively. The first curved surface 952, second curved surface 954, third curved surface 956, fourth curved surface 958, fifth curved surface 962, sixth curved surface 964, seventh curved surface 966, and eighth curved surface 968 may share similar shapes and dimensions.

The first curved surface 952 may join the first edge 814 to the second inner surface 830b. Likewise, the second curved surface 954 may join the third edge 934 to the fourth inner surface 950b. The third curved surface 956 may join the second inner surface 830b to the fourth surface 822b, fifth surface 824b, and sixth surface 828b. The fourth curved surface 958 may join the fourth surface 822b, fifth surface 824b, and sixth surface 828b to the fourth inner surface 950b.

The fifth curved surface 962 may join the second edge 816 to the first inner surface 830a. Likewise, the sixth curved surface 964 may join the fourth edge 936 to the third inner surface 950a. The seventh curved surface 966 may join the first inner surface 830a to the first surface 822a, second surface 824a, and third surface 828a. The eighth curved surface 968 may join the first surface 822a, second surface 824a, and third surface 828a to the third inner surface 950a.

Thus, disclosed herein are systems and components for a relates generally to a vent that may be formed of a non-metal material, such as plastic and/or fiberglass, that may be coupled to the housing of an enclosure with a fastener. The vent may have a passage that extends through at least a hole the housing and fluidly couples the enclosure. The passage of the vent may be used to remove gases from the enclosure. The vent may be coupled via at least a fastener, such as a bolt, and at least a fastening section that may abut and couple to the surface of the housing of the enclosure. The vent may be coupled without the use of a sealant and/or press fitting. The vent and passage through the vent may be formed of a first portion and a second portion. The first portion may have a groove for which a seal, such an O-ring, may be positioned about and coupled to. The seal for the groove may be removable from the groove by hand without, and may be removed without degrading the seal. The fastening section may extend radially from the first portion. The fastening section may also extend radially from the second portion. The removable seal may at least prevent at least a liquid, such as lubricant, from exiting the enclosure from the holes in the housing about the vent. The removable seal may also prevent fluids, such as gases, from leaving the enclosure from the holes in the housing about the It will be appreciated that the configurations and routines disclosed herein are exemplary in nature, and that these specific embodiments are not to be considered in a limiting sense, because numerous variations are possible. For example, the above technology can be applied to V-6, I-4, I-6, V-12, opposed 4, and other engine types. Moreover, unless explicitly stated to the contrary, the terms “first,” “second,” “third,” and the like are not intended to denote any order, position, quantity, or importance, but rather are used merely as labels to distinguish one element from another. The subject matter of the present disclosure includes all novel and non-obvious combinations and sub-combinations of the various systems and configurations, and other features, functions, and/or properties disclosed herein.

As used herein, the term “approximately” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A mountable vent, comprising:
a first hollow portion with a seal groove;
a second hollow portion in fluid communication with the first hollow portion; an extension of the second hollow portion in fluid communication with the second hollow portion; and
a fastening portion with a compression limiter for at least one fastener to attach the mountable vent to a housing, where the fastening portion radially extends from the first hollow portion or the second hollow portion and is positioned between the seal groove and the extension.

2. The mountable vent of claim 1, wherein the compression limiter is molded-in.

3. The mountable vent of claim 1, wherein the mountable vent comprises plastic.

4. The mountable vent of claim 1, wherein the mountable vent comprises fiberglass.

5. The mountable vent of claim 1, wherein the compression limiter comprises metal.

6. The mountable vent of claim 1, wherein the extension of the second hollow portion extends perpendicularly from the first hollow portion.

7. The mountable vent of claim 6, wherein the fastening portion radially extends from the first hollow portion in a direction opposite to the extension.

8. The mountable vent of claim 7, wherein the fastening portion includes a flat extension including the compression limiter and a receiving opening for the at least one fastener, the receiving opening has a central axis that is parallel to a central axis of the first hollow portion.

9. The mountable vent of claim 8, wherein the central axis of the first hollow portion is a single, straight, central axis.

10. The mountable vent of claim 8, wherein flat extension includes a first platform and a second platform parallel to the first platform, the flat extension further including a recess between the first platform and the second platform.

11. The mountable vent of claim 10, wherein the seal groove is defined, on one side, by the fastening portion, and on an opposite side, by a land circumferentially surrounding the first hollow portion.

12. The mountable vent of claim 11, wherein the first platform and the second platform are positioned to be completely spaced away from the seal groove via an offset.

13. The mountable vent of claim 11, the recess includes first side and second side symmetric volumes, wherein,
the first platform;
the second platform;
and recesses may join a first cylinder and a second cylinder of the flat extension to form the first side and second side symmetric volumes, and the first side and second side symmetric volumes may be separated by a rib.

14. A gear box, comprising:
a housing; and
a vent mounted to the housing, the vent having a first hollow portion with a seal groove, a second hollow portion in fluid communication with the first hollow portion, an extension of the second hollow portion in fluid communication with the second hollow portion, and a fastening portion with a compression limiter for at least one fastener to mount the vent to the housing, where the fastening portion radially extends from the first hollow portion or the second hollow portion and is positioned between the seal groove and the second hollow portion.

15. The gear box of claim 14, wherein the housing includes a housing wall having a thickness, wherein the fastening portion is mounted directly on an outer surface of the housing, and where the first hollow portion extends through the thickness of the housing wall, with the seal groove positioned within the thickness of the housing wall.
